(19) United States
(12) Patent Application Publication
(10) Pub. No.: US 2026/0117098 A1
(43) Pub. Date: Apr. 30, 2026

(54) PRESSURE ACTIVATED ADHESIVES

(71) Applicant: Solventum Intellectual Properties Company, Maplewood, MN (US)

(72) Inventors: Hiroyuki Kobayashi, Tokyo (JP); Audrey A. Sherman, Woodbury, MN (US); Junkang J. Liu, Woodbury, MN (US); Nicholas D. Hart, Eagan, MN (US); Tong Wei, Woodbury, MN (US); David J. Franta, Woodbury, MN (US)

(73) Assignee: Solventum Intellectual Properties Company, Maplewood, MN (US)

(21) Appl. No.: 19/471,804

(22) PCT Filed: Mar. 26, 2024
(86) PCT No.: PCT/IB2024/052910

§ 371 Date: Oct. 2, 2025

Related U.S. Application Data
(60) Provisional application No. 63/457,842, filed on Apr. 7, 2023.

(51) Int. Cl. C09J 7/38; C09J 11/08

(52) U.S. Cl. CPC C09J 7/38; C09J 11/08; C09J 2301/302; C09J 2301/408; C09J 2483/00

(57) ABSTRACT

Pressure activated adhesive articles include a substrate and a pressure activated adhesive layer disposed on the substrate. The pressure activated adhesive layer is a crosslinked adhesive composition, with a siloxane polymer that has been crosslinked, and at least one siloxane tackifying resin. The pressure activated adhesive is non-adhesive at room temperature having a Tg of at least 50° C. as measured by DMA (Dynamic Mechanical Analysis), but upon application of pressure to the adhesive layer the adhesive layer adheres to a substrate.

### SUMMARY

Disclosed herein are pressure activated adhesives, pressure activated adhesive compositions, and adhesive constructions prepared from pressure activated adhesive articles. Pressure activated adhesive articles comprise a first substrate with a first major surface and a second major surface, and a pressure activated adhesive layer disposed on at least of a portion of the second major surface of the first substrate. The pressure activated adhesive layer comprises a crosslinked adhesive composition. The crosslinked adhesive composition comprises at least one siloxane polymer that has been crosslinked, and at least one siloxane tackifying resin. The adhesive composition is a pressure activated adhesive that is non-adhesive at room temperature having a Tg of at least 50° C. as measured by DMA (Dynamic Mechanical Analysis), but upon application of pressure to the adhesive layer the adhesive layer adheres to a substrate.

Also disclosed are methods of forming adhesive constructions. In some embodiments, the method of forming an adhesive construction comprises providing a surface to be bonded, providing an adhesive article with an exposed adhesive surface, where the exposed adhesive surface comprises a pressure activated adhesive, contacting the exposed adhesive surface of the adhesive article to the surface to be bonded, and applying pressure to adhere the adhesive article to the surface to be bonded. The pressure activated adhesives are described above.

### DETAILED DESCRIPTION

Adhesives have been used for a variety of marking, holding, protecting, sealing, masking, and lidding purposes. Adhesive tapes generally comprise a backing or substrate, and an adhesive. One type of adhesive, a pressure sensitive adhesive, is particularly useful for many applications.

Pressure sensitive adhesives are well known to one of ordinary skill in the art to possess certain properties at room temperature including the following: (1) aggressive and permanent tack, (2) adherence with no more than finger pressure, (3) sufficient ability to hold onto an adherend, and (4) sufficient cohesive strength to be removed cleanly from the adherend. Materials that have been found to function well as pressure sensitive adhesives are polymers designed and formulated to exhibit the requisite viscoelastic properties resulting in a desired balance of tack, peel adhesion, and shear strength. The most commonly used polymers for preparation of pressure sensitive adhesives are natural rubber, synthetic rubbers (e.g., styrene/butadiene copolymers (SBR) and styrene/isoprene/styrene (SIS) block copolymers), various (meth)acrylate (e.g., acrylate and methacrylate) copolymers and silicones. Each of these classes of materials has advantages and disadvantages.

A wide range of adhesive articles involve the placement of the adhesive article onto a surface to provide protection of the surface and to seal the surface, typically for a limited amount of time and then the article is removed. Examples of this include protection films, sealing tapes, and the like. Among the uses for article sealing that are becoming more prevalent are cover tapes of medical diagnostic devices (microplates or microcards). These uses provide particular problems because many medical diagnostic microplates have a contoured surface area with an array of micro channels and microcavities and the adhesive article has to conform to a specifically shaped surface when mechanically applied. Mechanical application of the adhesive article and achieving perfect sealing to the device surface can be difficult. There are a number of reasons for this difficulty. In some instances, the adhesives may touch other surfaces briefly before being adhered to the adherend surface. In this event, the adhesive article is bonded to unwanted surfaces prematurely, and therefore fails to seal of the diagnostic device. Additionally, if the adhesive article is misaligned upon contacting of the adhesive article to the surface, it can be difficult and time consuming to remove and re-adhere the adhesive article correctly to the surface. This process is referred to as “repositionability”.

A number of techniques have been developed to produce adhesive articles with ease of application features. Typically, these techniques involve modifying the adhesive surface by imparting a microstructured surface to the adhesive surface or disposing non-adhesive elements to the adhesive to prevent the adhesive surface from contacting and adhering to the surface prematurely. In this way the adhesive article can be placed in the proper alignment with the surface that it is to be adhered to and then the adhesive is typically pressed onto the substrate surface to form the adhesive bond. An example of such a technique is described in PCT Publication No. WO 03/05019, which describes “tack-on-demand” adhesives where spacers (such as beads) are placed on the adhesive surface at intervals. The spacers provide a barrier between the substrate surface and the adhesive layer to provide repositionability, and upon the application of pressure, the adhesive surface contacts the substrate surface, and an adhesive bond is formed.

While this technique has been effective in some applications, it also has drawbacks. Because these elements are non-adhesive, the regions where they are located on the adhesive surface are spots of non-adhesion and when attached to a substrate surface can form regions of adhesive failure and seal failure. Adhesive failure can cause the adhesive article to lift off of the substrate surface or can cause leaks and wrinkles and/or other non-uniformities in the adhered adhesive article. Additionally, disposing the non-adhesive elements to the adhesive surface can be a very complicated process. Additionally, frequently adhesive articles are supplied either disposed on a release liner or in the form of a roll, where the adhesive surface contacts the back surface of the adhesive article upon formation of the roll. Having protrusions or other spacers located on the surface of the adhesive layer generally requires a specialized liner with depressions to accommodate the spacers on the adhesive surface. Therefore, it is desirable to develop new and different adhesive articles capable of repositionability.

Another desirable feature for adhesives is being able to selectively adhere to surfaces, by which it is meant to have a portion of the adhesive layer adhere without having the entire adhesive layer adhere or having portions of an adhesive layer adhere more strongly than other portions of the adhesive layer. Recently a journal article by Deneke et al. in Adv. Mater. 2023, 35, 2207337 describes what they term “Pressure-Tunable Adhesives” (PTAs). These adhesives are contrasted with pressure sensitive adhesives because PSAs adhere with very little pressure, but additional pressure does not increase the level of adhesion, whereas the PTAs demonstrate increased adhesion with increased pressure. They present a highly tunable, scalable, and versatile PTA that is based on the self-assembly of stiff microscale asperities on an elastomeric substrate via thin film dewetting. In this way, PTAs have physically altered adhesive layers, where the asperities alter the physical properties of the adhesive surface.

Another complicating feature for adhesive articles, especially in medical applications, is that many of the surfaces to which it is desired to attach adhesive articles are prepared from inert, non-reactive and thus low surface energy materials. However, since it is desired to adhere medical adhesive articles to a wide range of surfaces, the adhesive articles should be able to adhere to a wide range of surfaces.

In this disclosure, adhesive articles are described that are repositionable, not by modifying the surface structure of the adhesive so that the adhesive does not contact the substrate surface upon application of the adhesive article to the substrate surface, but rather by modifying the adhesive chemistry to make it “pressure activatable”. The currently described adhesives have very low or no initial wet out on the substrate surface to permit repositionability, but upon application of pressure the adhesive forms an adhesive bond to the substrate surface.

The term “adhesive” as used herein refers to polymeric compositions useful to adhere together two adherends. Examples of adhesives are pressure sensitive adhesives, heat activated adhesives and pressure activated adhesives.

Pressure sensitive adhesive compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as pressure sensitive adhesives are polymers designed and formulated to exhibit the requisite viscoelastic properties resulting in a desired balance of tack, peel adhesion, and shear holding power. Obtaining the proper balance of properties is not a simple process.

Heat activated adhesives are non-tacky at room temperature but become tacky and capable of bonding to a substrate at elevated temperatures. These adhesives usually have a T_{g} (glass transition temperature) or melting point (Tₘ) above room temperature. When the temperature is elevated above the T_{g} or Tₘ, the storage modulus usually decreases and the adhesive becomes tacky.

Pressure Activated Adhesive (PAA), the term pressure activated adhesive refers to an adhesive that is different from a Pressure Sensitive Adhesive or a Heat Activated Adhesive in that it is non-adhesive at room temperature, being non-tacky or having extremely low tack at room temperature. PAAs can have a Young's Modulus as measured by DMA (Dynamic Mechanical Analysis) at room temperature that is equal to or greater than 1.0 MPa, above the Dahlquist Criterion for tack of 0.3 MPa, is not self-wetting, and has a Tg above 50° C. as measured by as measured by DMA (Dynamic Mechanical Analysis). While the PAAs are not activated by heat, layers of the adhesive, upon the application of pressure, adhere to a substrate. In other words, a layer of the adhesive does not adhere to a substrate surface until substantial pressure is applied to the adhesive layer, and upon the application of pressure the adhesive layer forms an adhesive bond to the substrate. The definition of pressure sensitive adhesives states that the adhesive adheres with finger pressure, in other words a very light pressure. Pressure activated adhesives on the other hand require the application of a pressure that is greater than finger pressure.

Adhesive properties used herein include “self-wetting” and “repositionable”, the term self-wetting refers to the ability of an adhesive layer to spontaneously wet a substrate surface to which the adhesive layer is contacted. Self-wetting is often a property of pressure sensitive adhesives but is not a property of the pressure activated adhesives of this disclosure. Repositionability refers to the ability of an adhesive layer to be placed on a surface and be easily removed from the surface and re-attached to the surface. Repositionability is often not a property of pressure sensitive adhesives, especially those that are self-wetting, but it is a property of the pressure activated adhesives of this disclosure.

The term “(meth)acrylate” refers to monomeric acrylic or methacrylic esters of alcohols.

Acrylate and methacrylate monomers or oligomers are referred to collectively herein as “(meth)acrylates”. Materials referred to as “(meth)acrylate-functional” are materials that contain one or more (meth)acrylate groups.

The terms “siloxane-based” as used herein refer to polymers or units of polymers that contain siloxane units. The terms silicone or siloxane are used interchangeably and refer to units with dialkyl or diaryl siloxane (—SiR₂O—) repeating units.

The terms “room temperature” and “ambient temperature” are used interchangeably to mean temperatures in the range of 21° C. to 25° C.

The terms “Tg” and “glass transition temperature” are used interchangeably. If measured, Tg values are determined by Dynamic Mechanical Analysis (DMA) at a frequency of 1 Hz, unless otherwise indicated. Typically, Tg values for copolymers are not measured but are calculated using the well-known Fox Equation, using the homopolymer Tg values provided by the monomer supplier, as is understood by one of skill in the art.

The term “adjacent” as used herein when referring to two layers means that the two layers are in proximity with one another with no intervening open space between them. They may be in direct contact with one another (e.g. laminated together) or there may be intervening layers.

The terms “polymer” and “macromolecule” are used herein consistent with their common usage in chemistry. Polymers and macromolecules are composed of many repeated subunits. As used herein, the term “macromolecule” is used to describe a group attached to a monomer that has multiple repeating units. The term “polymer” is used to describe the resultant material formed from a polymerization reaction.

The term “alkyl” refers to a monovalent group that is a radical of an alkane, which is a saturated hydrocarbon. The alkyl can be linear, branched, cyclic, or combinations thereof and typically has 1 to 20 carbon atoms. In some embodiments, the alkyl group contains 1 to 18, 1 to 12, 1 to 10, 1 to 8, 1 to 6, or 1 to 4 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethythexyl.

The term “aryl” refers to a monovalent group that is aromatic and carbocyclic. The aryl can have one to five rings that are connected to or fused to the aromatic ring. The other ring structures can be aromatic, non-aromatic, or combinations thereof. Examples of aryl groups include, but are not limited to, phenyl, biphenyl, terphenyl, anthryl, naphthyl, acenaphthyl, anthraquinonyl, phenanthryl, anthracenyl, pyrenyl, perylenyl, and fluorenyl.

The terms “free radically polymerizable” and “ethylenically unsaturated” are used interchangeably and refer to a reactive group which contains a carbon-carbon double bond which is able to be polymerized via a free radical polymerization mechanism.

Unless otherwise indicated, the terms “optically transparent”, and “visible light transmissive” are used interchangeably, and refer to an article, film or adhesive that has a high light transmittance over at least a portion of the visible light spectrum (about 400 to about 700 nm). Typically, optically transparent articles have a visible light transmittance of at least 80% and a haze of less than 5%.

Unless otherwise indicated, “optically clear” refers to an adhesive or article that has a high light transmittance over at least a portion of the visible light spectrum (about 400 to about 700 nm), and that exhibits low haze, typically less than about 5%, or even less than about 2%. In some embodiments, optically clear articles exhibit a haze of less than 1% at a thickness of 50 micrometers or even 0.5% at a thickness of 50 micrometers. Typically, optically clear articles have a visible light transmittance of at least 85%, often higher such as 88%, 90%, or even 91% or higher.

The term “solvent-free” as used herein when referring to PAA coating compositions means that the PAA coating composition is essentially free of solvent. By essentially free of solvent, it is meant that no solvent is added to the composition so that the coating composition is essentially 100% solids and the coating composition is compounded, coated and cured with no provision for the removal of solvent.

Disclosed herein are pressure activated adhesive (PAA) articles. The pressure activated adhesive article comprises a first substrate with a first major surface and a second major surface, and an adhesive layer disposed on at least of a portion of the second major surface of the first substrate. The adhesive layer comprises a crosslinked adhesive composition, wherein the crosslinked adhesive composition comprises at least one siloxane polymer that has been crosslinked, and at least one siloxane tackifying resin. The adhesive composition is a pressure activated adhesive that is non-adhesive at room temperature and has a Tg of at least 50° C. as measured by DMA (Dynamic Mechanical Analysis). In some embodiments, the adhesive composition has a Young's Modulus of at least 1.0 MPa at room temperature as measured by DMA and is essentially not self-wetting, but upon application of pressure to the adhesive layer, the adhesive layer adheres to a substrate surface.

The pressure activated adhesive articles comprise a first substrate. Examples of suitable first substrates are a release liner or a tape backing. Release liners are well known in the adhesive arts and are films from which adhesive compositions or coatings can be readily removed. Exemplary release liners include those prepared from paper (e.g., Kraft paper) or polymeric material (e.g., polyolefins such as polyethylene or polypropylene, ethylene vinyl acetate, polyurethanes, polyesters such as polyethylene terephthalate, and the like, and combinations thereof). At least some release liners are coated with a layer of a release agent such as a fluorosilicone-containing material or a fluorocarbon-containing material.

Examples of suitable tape backings include a polymeric film, a foil, a fabric, a non-woven, a foam, a paper, a mesh, or a combination thereof. In some embodiments, the backing comprises an optically clear polymeric film without background fluorescence. In some embodiments, the optical clear polymeric film backing has punch resistance. Examples of such backings, methods of making such films, and methods for testing their optical properties are described, for example, in U.S. Pat. Nos. 3,645,835 and 4,595,001. Typically, such backings are polyolefin films.

In many embodiments, the backing is conformable to contour surfaces. As such, when the backing is applied to a contour surface, it conforms to the surface even when the surface is moved. Examples of such backings can be found in U.S. Pat. Nos. 5,088,483 and 5,160,315, and include elastomeric polyurethane, polyester, or polyether block amide films. These films have a combination of desirable properties including resiliency, high moisture vapor permeability, and transparency.

In some embodiments, the tape backing is optically transparent and comprises polyester, polycarbonate, PS (polystyrene), CBC (cyclic block copolymers), polyolefin, including but not limited to BOPP (biaxially oriented polypropylene, COP (cyclic olefin polymer), COC (cyclic olefin copolymer), polypentene, glass film (such as the Ultra Thin glass film commercially available from Nippon Electric Glass), or a combination thereof.

In some embodiments, the pressure activated adhesive articles comprise a second substrate. In many embodiments, the second substrate is a release liner. The second substrate has a first major surface and a second major surface where the first major surface of the second substrate comprises a release coating and is disposed on the adhesive layer. If the first substrate is also a release liner, the pressure activated tape article is a transfer tape.

The pressure activated adhesive articles of this disclosure also comprise an adhesive layer disposed on at least of a portion of the second major surface of the first substrate. The adhesive layer comprises a crosslinked adhesive composition, where the crosslinked adhesive composition comprises at least one siloxane polymer that has been crosslinked, and at least one siloxane tackifying resin. It should be understood that the at least one siloxane polymer may refer to a single type of siloxane polymer or a mixture of siloxane polymers.

A wide range of siloxane polymers are suitable. In this disclosure, four types of siloxane polymers are particularly suitable. These types are silanol-functional siloxane polymers that have been end-capped with a siloxane tackifying resin, silanol-functional siloxane polymers that have been end-capped with a siloxane tackifying resin and also contain at least one functional group, non-functional siloxane polymers, and siloxane block copolymers. Each of these types is described in detail below. Mixtures and blends of these types of siloxane polymers can also be used if desired.

In some embodiments, the siloxane polymers comprise a silanol-functional siloxane polymer that has been end-capped with a siloxane tackifying resin. Examples of end-capped polymers are described in PCT Publication No. WO 2020/099999. The silanol groups present on the silanol-functional siloxane polymers condense with hydroxyl groups on the siloxane tackifying resin to form the end-capped polymers.

Generally, the silanol-functional siloxane polymers are fluids that are described by Formula 1 below:

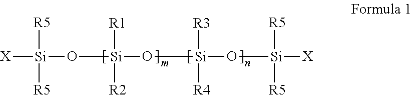

where R1, R2, R3, and R4 are independently selected from the group consisting of an alkyl group, or an aryl group, each R5 is an alkyl group, each X is a hydroxyl group, and n and m are integers, and at least one of m or n is not zero. In some embodiments, R1 and R2 are alkyl groups and n is zero, i.e., the material is a poly(dialkylsiloxane). In some embodiments, the alkyl group is a methyl group, i.e., poly(dimethylsiloxane) (“PDMS”). In some embodiments, R1 is an alkyl group, R2 is an aryl group, and n is zero, i.e., the material is a poly(alkylarylsiloxane). In some embodiments, R1 is a methyl group and R2 is a phenyl group, i.e., the material is poly(methylphenylsiloxane). In some embodiments, R1 and R2 are alkyl groups and R3 and R4 are aryl groups, i.e., the material is a poly(dialkyldiarylsiloxane). In some commercially available embodiments, R1, R2, R3, R4, and R5 are all methyl groups, making the material a polydimethyl siloxane or PDMS material. In other embodiments, at least some of the R1, R2, R3, and R4 are aryl groups.

The dynamic viscosity of the silanol end group-containing linear organopolysiloxane at 25° C. can be generally about 50 mm²/sec or greater, 500 mm²/sec or greater, about 1000 mm²/sec or greater, or about 2000 mm²/sec or greater, and about 10,000,000 mm²/sec or less, about 1,000,000 mm²/sec or less, or about 500,000 mm²/sec or less.

The silanol equivalent of the silanol end group-containing linear organopolysiloxane can be also about 300,000 g/mol or less, about 200,000 g/mol or less, about 100,000 g/mol or less, about 50,000 g/mol or less, about 40,000 g/mol or less, or about 500 g/mol or greater, or about 1000 g/mol or greater.

The silanol-functional siloxane polymers are end-capped with siloxane tackifying resins. Siloxane tackifying resins have in the past been referred to as “silicate” tackifying resins, but that nomenclature has been replaced with the term “siloxane tackifying resin”. In this disclosure, the terms “silicate” and “siloxane” when referring to tackifying resins are used interchangeably.

Suitable siloxane tackifying resins include those resins composed of the following structural units M (i.e., monovalent R′₃SiO_{1/2} units), D (i.e., divalent R′₂SiO_{2/2} units), T (i.e., trivalent R′SiO_{3/2} units), and Q (i.e., quaternary SiO_{4/2} units), and combinations thereof. Typical exemplary siloxane resins include MQ siloxane tackifying resins, MQD siloxane tackifying resins, and MQT siloxane tackifying resins. These siloxane tackifying resins usually have a number average molecular weight in the range of 100 to 50,000-gm/mole, e.g., 500 to 15,000 gm/mole and generally R′ groups are methyl groups.

MQ siloxane tackifying resins are copolymeric resins where each M unit is bonded to a Q unit, and each Q unit is bonded to at least one other Q unit. Some of the Q units are bonded to only other Q units. However, some Q units are bonded to hydroxyl radicals resulting in HOSiO_{3/2} units (i.e., “T^{OH}” units), thereby accounting for some silicon-bonded hydroxyl content of the siloxane tackifying resin.

According to the molecular weight of MQ resin, the level of silicon bonded hydroxyl groups (i.e., silanol) on the MQ resin may be 10 weight percent, 5 weight percent, 1.0 weight percent, or 0.5 weight percent based on the weight of the silicate tackifying resin.

Suitable siloxane tackifying resins are commercially available from sources such as Dow Corning (e.g., DC 2-7066), Momentive Performance Materials (e.g., SR545 and SR1000), and Wacker Chemie AG (e.g., BELSIL TMS-803).

The end-capped linear organopolysiloxane with the silicate resin may be produced by the condensation reaction of the silanol end group-containing linear organopolysiloxane and the silicate resin. The condensation reaction can be generally carried out by using a catalyst. Examples of catalysts include a metal hydroxide including lithium hydroxide, sodium hydroxide, potassium hydroxide, and calcium hydroxide; a carbonate salt including sodium carbonate and potassium carbonate; a bicarbonate salt including sodium bicarbonate; a metal alkoxide including sodium methoxide or potassium butoxide; an organic metal including butyl lithium; a complex of potassium hydroxide and a siloxane; a nitrogen compound including ammonia gas, aqueous ammonia solution, 1,5-diazabicyclo [4.3.0]-5-nonene, 1,8-diazabicyclo[0.4.0]-7-undecene (DBU), pyridine, N,N-dimethyl-4-aminopyridine, guanidine, 2,4,6-tris(dimethylaminomethyl)phenol, methylamine, trimethylamine, and triethylamine. Since the catalyst can be easily removed by using reduced pressure stripping, ammonia gas or aqueous ammonia solution is advantageously used as the catalyst.

The condensation reaction may be carried out in the presence of a solvent or in the absence of a solvent. Examples of suitable solvents include aromatic hydrocarbons including toluene and xylene; a linear or branched aliphatic hydrocarbon including hexane, heptane, octane, isooctane, decane, cyclohexane, methylcyclohexane, and isoparaffin; a hydrocarbon-based solvent including industrial gasoline, petroleum benzine, and solvent naphtha; a ketone including acetone, methyl ethyl ketone, 2-pentanone, 3-pentanone, 2-hexanone, 2-heptanone, 4-heptanone, methyl isobutyl ketone, diisobutyl ketone, acetonyl acetone, and cyclohexanone; an ester including ethyl acetate, propyl acetate, isopropyl acetate, butyl acetate, and isobutyl acetate; an ether including diethylether, dipropylether, diisopropylether, dibutylether, 1,2-dimethoxyethane, and 1,4-dioxane; a substituted acetate solvent including 2-methyoxyethyl acetate, 2-ethyoxyethyl acetate, propylene glycol monomethylether acatate, and 2-butoxyethyl acetate; and mixtures thereof. In some embodiments, the solvent is an aromatic hydrocarbon, a linear or branched aliphatic hydrocarbon, or a mixed solvent of linear or branched aliphatic hydrocarbon and ether, ester, or substituted acetate. If the condensation reaction is carried out in the absence of a solvent, it is typically carried out in a twin screw extruder.

The temperature of the condensation reaction can be generally about 20° C. or higher, about 30° C. or higher, or about 40° C. or higher, and about 150° C. or lower, about 110° C. or lower, or about 80° C. or lower. The condensation reaction may be carried out at the reflux temperature of the optional solvent.

The condensation reaction can be carried out until the about 50% or greater, about 70% or greater, or about 90% or greater of the silanol groups in the silanol end group-containing linear organopolysiloxane is reacted. In some embodiments, substantively all of the silanol group of the silanol end group-containing linear organopolysiloxane are consumed by the condensation reaction with the silicate resin by using an excess molar equivalent of the silicate.

Although the time of the condensation reaction is not particularly limited, the time can be generally about 0.5 hour or more, or about 1 hour or more, and about 48 hours or less, or about 24 hours or less.

After the condensation reaction, a neutralizer for neutralizing the base catalyst may be added, as needed. Examples of the neutralizer include an acidic gas including hydrogen chloride and carbon dioxide; an organic acid including octylic acid and citric acid; a mineral acid including hydrochloric acid, sulfuric acid and phosphoric acid. In addition to the neutralization, or instead of the neutralization, the base catalyst can be removed by vacuum devolatilization or washing with water.

In addition to the neutralization and vacuum devolatilization of the catalyst, an additional end capping group for residual silanol groups left after the condensation reaction may also be used, as needed or desired. The most typical example is a silylation agent, and the examples include chlorotrimethylsilane, 1,1,1,3,3,3-hexamethyldisilazane, and N,N′-bis(trimethylsilyl)urea. Since silylamine types such as 1,1,1,3,3,3-hexamethyldisilazane do not form a salt as a byproduct, the amines formed in subsequent processes can be removed by vacuum devolatilization or thermal drying process.

In addition to the first type of siloxane polymers described above, a second type of end-capped polymers can be formed that contain additional functional groups. These polymers can be described by Formula 1A below:

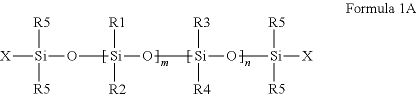

where R1, R2, R3, and R4 are independently selected from the group consisting of an alkyl group, an aryl group, or a functional group, each R5 is an alkyl group, each X is a hydroxyl group, and n and m are integers, and at least one of m or n is not zero. Suitable functional groups include alkene groups, vinyl ether groups, (meth)acrylate groups, and thiol groups. Functional polysiloxanes that are described by Formula 1A include those where at least one of R1, R2, R3, and R4 is a functional group and polysiloxane can be described as: a vinyl-functional or allyl-functional polysiloxane (alkene groups); a vinyl ether-functional polysiloxane (vinyl ether groups); a (meth)acrylate-functional polysiloxane ((meth)acrylate groups); a mercapto-functional polysiloxane (thiol groups); or a combination thereof.

The functionalized siloxane polymer is crosslinked not only by the methods described below, namely peroxide curing and curing with ionizing radiation, but also by free radical polymerization (with vinyl ether and (meth)acrylate-functional polymers), and thiol-ene reactions (when the siloxane polymers contain both alkene groups and thiol groups). While a single siloxane polymer could contain both functional groups of a reactive couple, such as for example an alkene group and a thiol group, it is more common to use blends of alkene-functional siloxanes and thiol-functional siloxanes. Typically, these curing reactions require catalysts or initiators and may require the input of heat or UV radiation. These curing reactions are further described below.

In other embodiments, the siloxane polymer comprises a non-functional siloxane polymer (the third type), or a siloxane block copolymer (the fourth type).

Examples of siloxane polymers that are non-functional fluids are described by Formula 1B below:

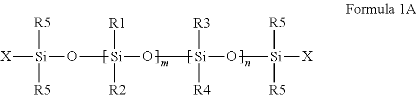

where R1, R2, R3, and R4 are independently selected from the group consisting of an alkyl group, an aryl group and a functional group, each R5 is an alkyl group, each X is a non-functional group, and n and m are integers, and at least one of m or n is not zero.

Formula 1 described above has X=OH. In the current context, X=OH is considered a non-functional siloxane polymer since the hydroxyl group is not reactive to form a crosslinked siloxane. Recently, silicone adhesives made by such non-functional siloxane polymers have been described in US Patent Publication No. 2011/0206924 (Liu et al). These materials are ones described by Formula 1B with X=R5, and ones described by Formula 1B where X=OH. The materials where X=OH are considered to be “non-functionalized materials” in this reference because the hydroxyl groups are not used as “functional groups” for the curing reactions, that is not to say, the polymerization reaction does not involve reaction with the hydroxyl groups. These “non-functional materials” have been found to crosslink upon exposure to electron beam or gamma radiation to generate cured siloxane networks.

A wide variety of non-functionalized siloxane polymers can be used to form the adhesive layer of the current articles. One suitable class are the hydroxyl-functional materials described above as precursors for the end-capped siloxane polymers. Other materials include non-functional materials of Formula 1B where X=R5. Many examples of such materials are commercially available.

An advantage of the use of non-functionalized polysiloxane materials is that the non-functionalized materials can be used as is and crosslinked without the need for initiators or catalysts.

Another class of suitable siloxane polymers are siloxane block copolymers including for example, urea-based siloxane copolymers, oxamide-based siloxane copolymers, amide-based siloxane copolymers, urethane-based siloxane copolymers, and mixtures thereof.

Useful siloxane polyurea block copolymers are disclosed in, e.g., U.S. Pat. Nos. 5,512,650, 5,214,119, 5,461,134, and 7,153,924 and PCT Publication Nos. WO 96/35458, WO 98/17726, WO 96/34028, WO 96/34030 and WO 97/40103.

Another useful class of siloxane polymers are oxamide-based polymers such as polydiorganosiloxane polyoxamide block copolymers. Examples of polydiorganosiloxane polyoxamide block copolymers are presented, for example, in US Patent Publication No. 2007-0148475.

Another useful class of siloxane block copolymers is amide-based siloxane polymers. Such polymers are similar to the urea-based polymers, with amide linkages (—N(D)-C(O)—) instead of urea linkages (—N(D)-C(O)—N(D)-), where C(O) represents a carbonyl group and D is a hydrogen or alkyl group.

Another useful class of siloxane polymer is urethane-based siloxane polymers such as siloxane polyurea-urethane block copolymers. Siloxane polyurea-urethane block copolymers include the reaction product of a polydiorganosiloxane diamine (also referred to as siloxane diamine), a diisocyanate, and an organic polyol. Such materials are structurally very similar to the urea copolymer, except that the polymer includes urethane linkages (—N(D)-C(O)—O—) as well as urea linkages. Examples of such polymers are presented, for example, in U.S. Pat. No. 5,214,119.

The above-described siloxanes are crosslinked to form a polymeric siloxane matrix by thermal curing, radiation curing, or a combination thereof. The method or methods of crosslinking used depends upon the nature of siloxane polymer, that is to say whether it is a functional polymer or a non-functional polymer.

Functional siloxane polymers can be cured through the functional groups and can also be cured by the peroxide curing and ionizing radiation curing mechanisms described below. Depending upon the functional groups present on the siloxane polymers, the siloxane polymers can be crosslinked by free radical polymerization, or thiol-ene reactions.

Any of the siloxane polymers that contain ethylenically unsaturated groups can be cured by free radical polymerization. Typically, UV curing is used, meaning that a UV sensitive free radical initiator is present in the curable composition, and free radically polymerizable groups are present on the reactants. UV radiation is used to activate the free radical initiator which forms free radicals that initiate the curing reaction. The free radical polymerization can be carried out under a variety of conditions using a variety of different types of free radical initiators. Photoinitiators have been found to be particularly suitable as described in U.S. Pat. No. 5,514,730 (Mazurek).

Another curing mechanism is the thiol-ene reaction. In this reaction an ethylenically unsaturated group (an “ene”) reacts with a thiol group —SH, such that the —S and H groups add across the ene group to form a thioether linkage. The thiol-ene reaction is typically either a free radical initiated reaction and therefore includes a photoinitiator such as those described above or is a Michael Addition reaction catalyzed by either a base or a nucleophile.

An example of thermal curing that can be used with both functionalized and non-functionalized siloxanes, is peroxide curing. In peroxide curing, a peroxide initiator is added to an uncrosslinked siloxane composition. Upon heating the peroxide decomposes to form radicals which react with siloxane to form polymeric radicals. The polymeric radicals combine to form crosslinks. A wide variety of peroxides have been found to be suitable, such as di-acyl peroxides and peroxy esters. If the siloxane contains vinyl groups, the crosslinking reaction is generally much more facile and a class of peroxides called “vinyl specific peroxides” can be used to crosslink these materials. Examples of vinyl specific peroxides include di-aralkyl peroxides. alkyl-aralkyl peroxides, and di-alkyl peroxides. Thus, peroxide curing can be achieved either with non-functional siloxane materials or vinyl-functional siloxane materials.

A particularly suitable curing mechanism for forming the crosslinked siloxane matrix of this disclosure is radiation curing using ionizing radiation. A variety of ionizing radiation sources are suitable, especially E-beam (electron beam), and gamma ray radiation, as described in US Patent Publication No. 2011/0206924. An advantage of E-beam and gamma ray radiation is that non-functional siloxane materials are curable in this way and no initiators or catalysts are required. Additionally, the level of crosslinking desired can be controlled by controlling the level of E-beam or gamma ray radiation used. Further, unlike thermal crosslinking chemistries, E-beam crosslinking allows high viscosity solventless siloxane formulations to be hotmelt processed without concerns about pre-mature crosslinking in the siloxane compounding and bodying processes.

While peroxide curing can be used to form the crosslinked polymeric siloxane layer, in many embodiments an electron beam, gamma ray radiation, or a combination thereof is used to form the crosslinked polymeric siloxane layer, especially when the PAA is hot melt compounded in a twin screw extruder in the absence of a solvent.

A variety of procedures for E-beam and gamma ray curing are well-known. The cure depends on the specific equipment used, and those skilled in the art can define a dose calibration model for the specific equipment, geometry, and line speed, as well as other well understood process parameters.

Commercially available electron beam generating equipment is readily available. For the examples described herein, the radiation processing was performed on a Model CB-300 electron beam generating apparatus (available from Energy Sciences, Inc. (Wilmington, MA). Generally, a support film (e.g., polyester terephthalate support film) runs through a chamber. In some embodiments, a sample of uncured material with a liner (e.g., a fluorosilicone release liner) on both sides (“closed face”) may be attached to the support film and conveyed at the desired speed. In some embodiments, the support film is conveyed at a fixed speed of about 6.1 meters/min (20 feet/min). In some embodiments, a sample of the uncured material may be applied to one liner, with no liner on the opposite surface (“open face”). Generally, the chamber is inerted (e.g., the oxygen-containing room air is replaced with an inert gas, e.g., nitrogen) while the samples are e-beam cured, particularly when open-face curing.

Commercially available gamma irradiation equipment includes equipment often used for gamma irradiation sterilization of products for medical applications. Such equipment may be used to crosslink the polysiloxane layers of the present disclosure.

The adhesive layer also comprises at least one siloxane tackifying resin. A wide range of siloxane tackifying resins are suitable. Examples of suitable siloxane tackifying resins have been described above. A mixture of siloxane tackifying resins are suitable. A particularly suitable siloxane tackifying resin is MQ resin. Typically, the siloxane tackifying resin is added in a large amount relative to the total weight of the adhesive composition. In some embodiments, the siloxane tackifying resin is present in an amount of from 52%-72% by weight based on the total weight of the adhesive composition especially when MQ end capped siloxane polymers are used. In some embodiments, the amount may be at least 54%, at least 56%, at least 58%, at least 60%, or at least 62%.

The pressure activated adhesive layer can have a wide range of thicknesses. Typically, the adhesive layer has a thickness of at least 10 micrometers, up to 2 millimeters, and in some embodiments the thickness will be at least 15 micrometers up to 1 millimeter thick. A wide range of intermediate thicknesses are also suitable, such as 25-500 micrometers, 30-100 micrometers, and the like.

The pressure activated adhesive articles of the present disclosure have a variety of desirable properties besides the repositionability feature imparted by the pressure activatability of the adhesive. Because of their low tackiness, it might be expected that the adhesive would bond only weakly to substrate surfaces. It might also be expected that such adhesives would have poor adhesion to surfaces with a low surface energy. This however has been discovered to not be the case. In some embodiments, it has been found that the pressure activated adhesive articles are capable of bonding to a surface comprising a medium surface energy of from 36-300 dynes/cm (0.036-0.30 N/m) or a low surface energy of less than 36 dynes/cm (0.36 N/m). This is particularly useful as many medical surfaces to which one would like to adhere, for example, to provide a protective cover layer, are of a low or medium surface energy. The pressure activated adhesive articles can also form selective adhesive bonds by applying selective pressure. By selective pressure it is meant that pressure can be applied to some regions of the pressure activated adhesive articles to form bonds, but pressure is not applied to other regions so as to not form bonds in those regions. Also, stronger pressure can be applied in certain regions to form strong bonds while less pressure can be applied to other regions to form weaker bonds in those regions. There are a number of reasons why this may be useful, such as to adhere the article to a surface and yet make it easy to remove.

Examples of bonding surfaces with a low surface energy surface include films or rigid plates of PE (polyethylene), PS (polystyrene), PC (polycarbonate), PET (polyethylene terephthalate), PP (polypropylene), COC (cyclic olefin copolymer), COP (cyclic olefin polymer), PDMS (polydimethylsiloxane), or combinations thereof.

The desirable combination of properties of the pressure activated adhesive articles can be demonstrated by their low peel adhesion from a release liner, their low initial adhesion to a surface prior to application of pressure, and yet high peel adhesion to a low surface energy surface after application of pressure. In some embodiments, the pressure activated adhesive has low peel release from a release liner of less than 250 grams/inch (9.6 N/dm). Also, some embodiments have low initial adhesion to surfaces of less than 100 grams/inch (3.8 N/dm). However, upon application of pressure, some embodiments have a peel adhesion from PP of greater than 50 ounces/inch (55 N/dm).

As described above, a pressure activated adhesive is one that upon application of light pressure does not form a strong adhesive bond but rather upon the application of substantial pressure (such as more than finger pressure) forms a strong adhesive bond. One useful method for measuring such a pressure activation property is through the use of probe tack measurements. Probe tack measurements are well known in the adhesive arts. One particularly suitable method for use with pressure activated adhesives, is to press the probe to the adhesive surface at a relatively low pressure and measure the adhesion when the probe is removed from the adhesive surface. The probe is subsequently pressed to the adhesive surface at a higher pressure and again the adhesion is measured when the probe is removed from the adhesive surface. The adhesion values at different pressures can be ratioed according to the equation:

Ratio=(Adhesion at high pressure)/(Adhesion at low pressure).

The probe tack can be measured for pressure activated adhesive surfaces as well as for pressure sensitive adhesive surfaces. Since a variety of probes can be used at a variety of pressures, the absolute values of the ratios described above can vary, but in general when a PAA surface is tested the same way as a PSA, the ratio is lower, often much lower, for the PSA. Again, depending upon the specific conditions of testing, in some embodiments, when the high pressure is 30 times greater than the low pressure, the ratio can be at least 3 or greater, or 4 or greater for a PAA and less than 3 for a PSA. This is one of the many indicators that show the difference between a pressure activated adhesive and a pressure sensitive adhesive. A pressure sensitive adhesive is by definition permanently and aggressively tacky and thus when contacted with the probe even at low pressure still gives a high probe tack value. The pressure activated adhesives on the other hand, not only do not feel tacky to the touch, but also at low pressures give a low probe tack value. Upon application of higher pressure, however, the pressure activated adhesives give a high probe tack value. It should also be noted that the pressure activated adhesives of this disclosure are not only different from PSAs but also are different from the PTAs (Pressure-Tunable Adhesives) were additional pressure increases the adhesion of PTA to a substrate. The PAAs of this disclosure reach a maximum level of adhesion to a substrate upon the application of pressure and the adhesion level does not increase upon the application of higher and higher pressures.

Also disclosed herein are adhesive compositions. In some embodiments, the adhesive composition comprises at least one siloxane polymer that has been crosslinked, and at least 52% and up to 72% by weight of at least one siloxane tackifying resin based on the total weight of the adhesive composition. The adhesive composition is a pressure activated adhesive that is non-adhesive at room temperature and has a Tg of at least 50° C. as measured by DMA (Dynamic Mechanical Analysis). In some embodiments, the adhesive composition has a Young's Modulus of at least 1.0 MPa at room temperature as measured by DMA and is essentially non-tacky, but upon application of pressure to the adhesive layer, the adhesive layer adheres to a substrate surface. Suitable siloxane polymers, siloxane tackifying resins, and methods of crosslinking are described in detail above.

Also disclosed are methods for forming adhesive constructions. In some embodiments, the method comprises providing a surface to be bonded, providing a pressure activated adhesive article with an exposed pressure activated adhesive surface, contacting the exposed pressure activated adhesive surface of the pressure activated adhesive article to the surface to be bonded, and applying pressure to adhere the adhesive article to the surface to be bonded. The exposed pressure activated adhesive surface comprises a pressure activated adhesive. The pressure activated adhesive comprises a layer of a crosslinked adhesive composition comprising at least one siloxane polymer and at least one siloxane tackifying resin. Pressure activated adhesive compositions are described above. The pressure activated adhesive is non-adhesive at room temperature and has a Tg of at least 50° C. as measured by DMA (Dynamic Mechanical Analysis). In some embodiments, the adhesive composition has a Young's Modulus of at least 1.0 MPa at room temperature as measured by DMA and is essentially not self-wetting.

The pressure activated adhesive articles are described above and comprise a first substrate with a first major surface and a second major surface, where the substrate comprises a release liner or a tape backing, and a pressure activated adhesive layer disposed on at least of a portion of the second major surface of the substrate. Suitable substrates include those described above as first and second substrates. Pressure activated adhesive compositions are described above, comprising at least one siloxane polymer that has been crosslinked and at least 52% up to 72% by weight of at least one siloxane tackifying resin based on the total weight of the adhesive composition. Suitable siloxane polymers, siloxane tackifying resins, and methods of crosslinking are described in detail above.

In some embodiments, applying pressure to adhere the adhesive article to the surface to be bonded comprises applying uniform pressure to the adhesive article to form a uniform adhesive bond or applying selective pressure to selective regions of the adhesive article to form a selective adhesive bond. By selective pressure it is meant that pressure can be applied to some regions of the pressure activated adhesive articles to form bonds, but pressure is not applied to other regions so as to not form bonds in those regions. Also, stronger pressure can be applied in certain regions to form strong bonds while less pressure can be applied to other regions to form weaker bonds in those regions. In some embodiments, the method of forming the pressure activated adhesive articles comprises providing a substrate with a first major surface and a second major surface, where the first substrate comprises a release liner or a tape backing, disposing a coating composition on the second major surface of the first substrate to form a layer, where the coating compositions comprises at least one siloxane polymer and at least one siloxane tackifying resin, and crosslinking the layer by exposure to heat or ionizing radiation to form the pressure activated adhesive layer disposed on at least of a portion of the second major surface of the first substrate. The coating composition may be solvent-free or it may be in a solvent. Suitable solvents include aromatic solvents such as toluene, ketones such as MEK (methyl ethyl ketone), and esters such as ethyl acetate. If in a solvent, the coated layer may be dried prior to crosslinking if needed or desired.

As described above, the at least one siloxane polymer comprises a silanol-functional siloxane polymer that has been end-capped with a siloxane tackifying resin, a silanol-functional siloxane polymer that has been end-capped with a siloxane tackifying resin and also contains at least one functional group, a non-functional siloxane polymer, or a siloxane block copolymer.

As described above, the crosslinking of the at least one siloxane polymer can be carried out in a variety of ways depending upon the nature of the at least one siloxane polymer. The crosslinking of the at least one siloxane polymer comprises free radical polymerization, a thiol-ene reaction, exposure to ionizing radiation comprising e-beam, gamma radiation, or a combination thereof, peroxide curing, or a combination thereof.

A wide range of surfaces to be bonded are suitable for use with the current method. In some embodiments, the surface to be bonded comprises a medium surface energy of from 36-300 dynes/cm (0.036-0.30 N/m) or a low surface energy of less than 36 dynes/cm (0.36 N/m).

In many embodiments, the formed adhesive constructions are designed to be temporary, and it is desirable that the adhesive construction be de-assembled. For example, if the adhesive article is designed to protect the surface of a device or article, it is desirable that the pressure activated adhesive article be attached to the surface of the device or article, and at a later time the pressure activated adhesive article is removed and discarded.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from FUJIFILM Wako Pure Chemical Corp. or Sigma-Aldrich Chemical Company; Milwaukee, Wisconsin unless otherwise noted. The following abbreviations are used: mm=millimeters; in =inches; g=grams; kg=kilograms; lb=pounds; Hz=Hertz; kV=kiloVolts; mA=milliAmps; Mrad=Megarads; mpm=meters per minute; Pa=Pascals; MPa=MegaPascals; sec=seconds; min=minutes; hrs=hours; N=Newtons; SP=Synthetic Polymer.

Table of Abbreviations

| Abbreviation or | |
|---|---|
| Trade Designation | Description |
| Silicone- 1 (S1) | Hydroxyl-functional polydimethylsiloxane fluid with a viscosity of 80 |
| | mm²/sec at 25° C. and a silanol equivalent weight of 1,200 g/mol, available from |
| | Momentive Performance Materials as “YF3800”. |
| Silicone-2 (S2) | Hydroxyl-functional polydimethylsiloxane fluid with a viscosity of 3,000 |
| | mm²/sec at 25° C. and a silanol equivalent weight of 20,000 g/mol, available |
| | from Momentive Performance Materials as “YF3057”. |
| Silicone-3 (S3) | Hydroxyl-functional polydimethylsiloxane fluid with a viscosity of 20,000 |
| | mm²/sec at 25° C. and a silanol equivalent weight of 36,000 g/mol, available |
| | from Momentive Performance Materials as “YF3807”. |
| Silicone-4 (S4) | Hydroxyl-functional polydimethylsiloxane gum paste with a silanol equivalent |
| | weight of 220,000 g/mol, available from Momentive Performance Materials as |
| | “YF3897”. |
| Silicone-5 (S5) | Trimethylsilyl-terminated polydimethylsiloxane fluid with a viscosity of |
| | 1,000,000 mm²/sec at 25° C., available from Wacker as “AK 1,000,000 |
| | (AK1M)”. |
| Silicone-6 (S6) | Polydiorganosiloxane polyoxamide copolymer as per “Preparatory Example |
| | 1” of U.S. Pat. No. 7,947,376 made from diamine of 14,000 molecular weight |
| Silicone-7 (S7) | Peroxide curing pressure sensitive adhesive in Toluene and Xylene (60% solid |
| | content), available from Shinetsu-Etsu Chemical Co. as “KR-100” |
| Silicone-8 (S8) | Polydiorganosiloxane polyoxamide copolymer as per “Preparatory Example |
| | 1” of U.S. Pat. No. 7,947,376 only made from diamine of 25,000 molecular |
| | weight |
| Tackifier-1 (T1) | MQ resin with less than 0.3% OH, available from Wacker as “MQ803TF”. |
| Tackifier-2 (T2) | MQ resin from Dow as “MQ1600” powder |
| Catalyst-1 | Aqueous ammonia solution (28%) available from FUJIFILM Wako Pure |
| | Chemical Corp. Chemical |
| Catalyst-2 | 1,8-diazabicyclo-[5.4.0]undec-7-ene, available from San-Apro as “DBU” |
| End capping | 1,1,1,3,3,3-Hexamethyldisilazane, available from Shinetsu Chemical as “SZ- |
| | 31” |
| Thermal radical | Benzoyl Peroxide in xylene (40%) available from NOF Corp. as “NYPER |
| initiator | BMT-K40” |
| Liner-1 (L1) | Fluorosilicone liner with 0.05 mm thickness available from Fujimoro Kogyo |
| | Co as “YC”. |
| Liner-2 (L2) | Non silicone type liner with 0.05 mm thickness available from TORAY as |
| | “PJ271” |
| Liner-3 (L3) | Fluorochemical liner with 0.1 mm thickness available from 3M Co as |
| | “Scotchpak 9955”. |
| Liner-4 (L4) | Fluorosilicone liner with 0.053 mm thickness available from Loparex as “2 CL |
| | PET 5100/5100” |
| Liner-5 (L5) | Fluorochemical release liner with 0.053 mm thickness as described in |
| | WO2022/144724 |
| Backing-1 (B1) | Transparent PET film with 0.05 mm thickness, available from Toyoba Co. as |
| | “COSMOSHINE A4360-50”. |
| Backing-2 (B2) | Primed PET film with 0.05 mm thickness available from Mitsubishi Co. as |
| | “HOSTAPHAN 3SAC”. |
| Backing-3 (B3) | E-glass plain weave glass fabric with 5.6 mil thickness (0.14 mm), available |
| | from JPS as “JPS 1162” |
| Backing-4 (B4) | Transparent BOPP film with 1.95 mil thickness (0.050 mm), available from |
| | Interplast as “AMTOPP TP50 BOPP” |
| Backing-5 (B5) | Aluminum foil with 2.2 mil thickness (0.053 mm), available from Ormet |
| | Aluminum |
| Silicone Adhesive | Addition cure Silicone PSA from Dow as DC7658 |
| (SA) | |
| Tape-1 | SCOTCH 3750 Packaging tape, commercially available from 3M company. |

### Example Set I. MQ-Resin Capped Examples

### Test Methods

### Tack—Probe Tack Test

The probe tack test was evaluated using a Texture analyzer.

The details of the test conditions are as follows.

| Probe size (diameter): | 7 | mm |
|---|---|---|
| Probe shape: | Round type (R½ inch curvature, | |
| | P/7D, Stable Micro Systems) | |
| Probe material: | Stainless steel | |
| Trigger force: | 1 | g |
| Target force: | 5, 20, 150 | g |
| Pre-test speed from | 0.05 | mm/sec |
| trigger to target force: | | |
| Contact time: | 1 | sec |
| Test speed: | 10 | mm/sec |

| | |
|---|---|
| Proportional-Integral- | 40 (P) 20 (I) 5 (D) |
| Differential (PID): | |
| Test atmosphere: | 23° C./50% RH |
| Repeat test number: | N6 |

The peak top value at test speed was recorded as the probe tack force, and the average value by n6 noted. In this disclosure, for lower loads (target force by 5 g), 25 g or less, or for intermediate loads (target force by 20 g), 40 g or less were defined as low tack.

### Liner Release Force

Liner release force was evaluated with an IMASS Model SP-2100 tester. Polyester film Backing-1 side of a test piece of 8 inches×1 inch (20 cm×2.5 cm) was applied on the measurement stage by double coated tape and the edge of the release film was pinched with a chuck to perform the measurement. Test speed was 12 in/min (30 cm/min) and the result is an average of 3 tests. The results are presented in N/25 mm.

In this disclosure, a release liner force of 0.3N/25 mm or less was defined as good liner release level.

### Peel Adhesion Force

Peel adhesion force was measured by TENSILON RTG-1250 (A&D Company, Limited) The details of the test conditions are as follows.

| | |
|---|---|
| Test mode: | 180°peel direction |
| Sample size: | 25 mm × 100 mm |
| Substrate: | Polypropylene (PP) |
| Surface treatment of substrate: | Wipe by IPA/heptane |
| Pressure condition: | 2 kg rubber roller-1round |
| | trip at 50 mm/sec |
| Delay time: | 20 min after pressure |
| Test atmosphere: | 23° C./50% RH |
| Test speed: | 300 mm/min |
| Repeat test number: | N3 |

The fracture mode was also recorded as follows:

| | |
|---|---|
| PO: | Pop off (it means clean peel) |
| AN: | Anchor failure |

In this disclosure, 7 N/25 mm or more was defined as good adhesive strength.

### Gel Fraction Ratio

The gel fraction ratio was calculated by initial sample weight (A) and residue sample weight (B) after soaking into enough solvent solution and drying.

| | |
|---|---|
| Sample size: | about 25 × 25 mm |
| Soaking solvent: | Toluene |
| Soaking time: | 24 hrs at room temperature |
| Drying condition: | 130° C. for 2 hrs |

$$Gel fraction ratio = ( A ) - ( B ) / ( A ) \%$$

### Rheology (Dynamic Mechanical Analysis)

Rheology data such as G′ (storage elastic modulus) and G″ (loss modulus), tan δ (=G″/G′) were measured by Dynamic Mechanical Analysis. Tg values were extracted by the peak of Tan δ. Sample preparation: 0.05 mm thickness PSA was laminated until over 2.0 mm, and then test piece was punched out to 8 mm.

| | |
|---|---|
| Device: | ARES-G2 (TA Instruments) |
| Test mode: | Temperature scan |
| Frequency: | 1 Hz |
| Temp. rising speed: | 5° C./min |
| Measurement temp.: | from −20 or 0° C. to 160° C. |

### Synthesis Examples

Condensation of Hydroxyl-functional Siloxanes with MO Resin Examples S4-S23 and Comparative Synthesis Examples CS1, CS2, and CS4-CS6

A series of condensation polymers were prepared by reacting Silicones and Tackifier-1 in a toluene solution with added Catalyst-1, for 1 day at 40° C., followed by 3 days at room temperature.

Condensation of Hydroxyl-functional Siloxanes with MO Resin Examples S1-S3 and Comparative Synthesis Examples CS3.

A series of condensation polymers were prepared by reacting Silicones and Tackifier-1 in a toluene solution with added Catalyst-2, for 1 day at 70° C., and end capping was added, followed by 12 hrs at 70° C.

The compositions are shown in Tables S1-S4

TABLE S1

| | CS1 | CS2 | CS3 | S1 | S2 | S3 | S4 | S5 | S6 |
|---|---|---|---|---|---|---|---|---|---|
| Silicone-1 | — | — | — | — | — | — | — | — | — |
| Silicone-2 | — | — | 48.0 | — | — | — | — | — | — |
| Silicone-3 | 50.0 | 50.0 | — | 46.0 | 42.0 | 40.0 | 38.0 | 36.0 | 18.0 |
| Silicone-4 | — | — | — | — | — | — | — | — | — |
| Tackifier-1 | 50.0 | 50.0 | 52.0 | 54.0 | 58.0 | 60.0 | 62.0 | 64.0 | 64.0 |
| Catalyst-1 | 0.7 | 0.7 | — | — | — | — | 0.7 | 0.7 | 0.6 |
| Catalyst-2 | — | — | 0.7 | 0.7 | 0.7 | 0.7 | — | — | — |
| End capping | — | — | 10.7 | 11.0 | 11.8 | 12.3 | — | — | — |
| Toluene | 42.1 | 42.1 | 42.1 | 42.1 | 42.1 | 42.1 | 42.1 | 42.1 | 34.6 |
| Total | 142.9 | 142.9 | 153.6 | 153.9 | 154.7 | 155.2 | 142.9 | 142.9 | 117.2 |
| Solids | 100.0 | 100.0 | 100.0 | 100.0 | 100.0 | 100.0 | 100.0 | 100.0 | 82.0 |
| Solids % | 70% | 70% | 65% | 65% | 65% | 64% | 70% | 70% | 70% |

TABLE S2

| | S7 | S8 | S9 | S10 | S11 | S12 | S13 | S14 | S15 |
|---|---|---|---|---|---|---|---|---|---|
| Silicone-1 | — | — | 2.5 | — | — | — | — | — | — |
| Silicone-2 | — | 36.0 | — | — | — | — | — | — | — |
| Silicone-3 | 28.8 | — | 33.5 | 34.0 | 23.8 | 17.0 | 7.3 | 32.9 | 32.0 |
| Silicone-4 | — | — | — | — | 10.2 | 17.0 | — | — | — |
| Tackifier-1 | 28.8 | 64.0 | 64.0 | 66.0 | 66.0 | 66.0 | 66.0 | 64.0 | 68.0 |
| Catalyst-1 | 0.5 | 0.7 | 0.7 | 0.7 | 0.7 | 0.8 | 0.5 | 0.7 | 0.7 |
| Catalyst-2 | — | — | — | — | — | — | — | — | — |
| End capping | — | — | — | — | — | — | — | — | — |
| Toluene | 24.4 | 42.1 | 42.1 | 42.1 | 42.1 | 65.8 | 30.9 | 40.8 | 42.1 |
| Total | 82.5 | 142.9 | 142.9 | 142.9 | 142.9 | 166.7 | 104.8 | 138.4 | 142.9 |
| Solids | 57.6 | 100.0 | 100.0 | 100.0 | 100.0 | 100.0 | 73.3 | 96.9 | 100.0 |
| Solids % | 70% | 70% | 70% | 70% | 70% | 60% | 70% | 70% | 70% |

TABLE S3

| | S16 | S17 | S18 | CS4 | CS5 | CS6 |
|---|---|---|---|---|---|---|
| Silicone-1 | — | — | — | — | — | — |
| Silicone-2 | — | — | — | — | — | — |
| Silicone-3 | 32.0 | 30.0 | 30.0 | 30.0 | 28.0 | 28.0 |
| Silicone-4 | — | — | — | — | — | — |
| Tackifier-1 | 68.0 | 70.0 | 70.0 | 70.0 | 72.0 | 72.0 |
| Catalyst-1 | 0.7 | 0.7 | 0.7 | 0.7 | 0.7 | 0.7 |
| Catalyst-2 | — | — | — | — | — | — |
| End capping | — | — | — | — | — | — |
| Toluene | 42.1 | 42.1 | 42.1 | 42.1 | 42.1 | 42.1 |
| Total | 142.9 | 142.9 | 142.9 | 142.9 | 142.9 | 142.9 |
| Solids | 100.0 | 100.0 | 100.0 | 100.0 | 100.0 | 100.0 |
| Solids % | 70% | 70% | 70% | 70% | 70% | 70% |

TABLE S4

| | CS7 | S19 | S20 | S21 | S22 | S23 |
|---|---|---|---|---|---|---|
| Silicone-1 | — | — | — | — | — | — |
| Silicone-2 | — | — | — | — | — | — |
| Silicone-3 | — | 34.0 | 34.0 | 34.0 | 36.0 | 34.0 |
| Silicone-4 | — | — | — | — | — | — |
| Tackifier-1 | — | 66.0 | 66.0 | 66.0 | 64.0 | 66.0 |
| Catalyst-1 | — | — | — | — | — | — |
| Catalyst-2 | — | 0.7 | 0.7 | 0.7 | 0.7 | 0.7 |
| End capping | — | — | — | — | — | — |
| Toluene | — | 42.1 | 42.1 | 42.1 | 42.1 | 42.1 |
| Total | N/A | 142.9 | 142.9 | 142.9 | 142.9 | 142.9 |
| Solids | N/A | 100.0 | 100.0 | 100.0 | 100.0 | 100.0 |
| Solids % | N/A | 70% | 70% | 70% | 70% | 70% |

N/A = Not Applicable

### Examples

### Preparation and Testing of Adhesive Compositions E1-E23 and Comparative Examples CE1-CE7

A series of adhesive compositions were prepared using the Synthesis Polymers (SP) corresponding to the CS or S polymers described above as shown in Tables 1-4.

For Examples CE1,2, CE4-6, E4-18 the composition solutions were applied to Liner-1 and dried at 70° C. for 10 minutes to form a layer of 0.05 mm thickness, Electron beams (E-beams) were irradiated from the adhesive surface side opposite to the Liner surface. The Backing-1 was laminated on the irradiation surface side and adhesion characteristics on the opposite side were evaluated.

For Examples CE3, 7, and E1-3 the composition solutions were applied to Backing-1 and dried at 70° C. for 10 minutes to form a layer of 0.05 mm thickness, E-beams were irradiated from the adhesive surface side opposite to the Backing-1 surface. The Liner-2 was laminated on the irradiation surface side and adhesion characteristics on the opposite side were evaluated. The Liner-2 was laminated on the irradiation surface side and adhesion characteristics on the opposite side were evaluated. For Rheology (Dynamic Mechanical Analysis), the composition solutions were applied to Liner-2 and dried at 70° C. for 10 minutes to form a layer of 0.05 mm thickness, E-beams were irradiated from the adhesive surface side. And then, a rheology was evaluated.

The E-beams was treated under the following conditions:

| Device: | BROADBEAM (PCT | |
|---|---|---|
| | Engineered Systems, LLC) | |
| Accelerated voltage: | 200 | kV |
| Current value: | 3, 5, 7 mA (3 mA: 3 Mrad, | |
| | 5 mA: 6 Mrad, 7 mA: 80 Mrad) | |
| Line speed: | 5 | mpm |

| | |
|---|---|
| Irradiated atmosphere: | At room temperature, |
| | in a nitrogen atmosphere |

For Examples E19-21 (thermal curing) the coating solutions were applied to Release Liner-1 and dried and cured at 70° C. for 5 min and 180° C. for 3 min to form a layer of 0.05 mm thickness. The Backing-1 was laminated on the adhesive surface side and adhesion characteristics on the opposite side were evaluated.

For Examples E22-E23 (gamma radiation curing) the coating solutions were applied to Release Liner-1 and dried at 70° C. for 10 minutes to form a layer of 0.05 mm thickness, and then it was laminated by Release Liner-1 on the adhesive layer. A gamma radiation was irradiated with both sides sandwiched between Release Liner under the following conditions: (0.6 Mrad (61.4 to 63.2 kGy). The Backing-1 was laminated on the coating surface side and adhesion characteristics on the opposite side were evaluated.

TABLE 1

| | CE1 | CE2 | CE3 | E1 | E2 | E3 | E4 | E5 | E6 |
|---|---|---|---|---|---|---|---|---|---|
| SP * | 142.9 | 142.9 | 153.6 | 153.9 | 154.7 | 155.2 | 142.9 | 142.9 | 117.2 |
| Silicone-5 | — | — | — | — | — | — | — | — | 18 |
| Silicone-6 | — | — | — | — | — | — | — | — | — |
| Silicone-7 | — | — | — | — | — | — | — | — | — |
| Extra | — | — | — | — | — | — | — | — | — |
| Tackifier (T1) | | | | | | | | | |
| Thermal | — | — | — | — | — | — | — | — | — |
| radical initiator | | | | | | | | | |
| Toluene | 23.8 | 23.8 | — | — | — | — | 23.8 | 23.8 | 31.5 |
| Total | 166.7 | 166.7 | 153.6 | 153.9 | 154.7 | 155.2 | 166.7 | 166.7 | 166.7 |
| Solids | 100.0 | 100.0 | 100.0 | 100.0 | 100.0 | 100.0 | 100.0 | 100.0 | 100.0 |
| Solids % | 60% | 60% | 65% | 65% | 65% | 64% | 60% | 60% | 60% |
| Total Silicone | 50.0 | 50.0 | 48.0 | 46.0 | 42.0 | 40.0 | 38.0 | 36.0 | 36.0 |
| Total Tackifier | 50.0 | 50.0 | 52.0 | 54.0 | 58.0 | 60.0 | 62.0 | 64.0 | 64.0 |
| E-beam Mrad | 0 | 6 | 6 | 3 | 6 | 6 | 6 | 6 | 6 |
| Gamm Mrad | — | — | — | — | — | — | — | — | — |
| Thermal cure | — | — | — | — | — | — | — | — | — |

* = Synthetic Polymers

TABLE 2

| | E7 | E8 | E9 | E10 | E11 | E12 | E13 | E14 | E15 |
|---|---|---|---|---|---|---|---|---|---|
| SP * | 82.5 | 142.9 | 142.9 | 142.9 | 142.9 | 166.7 | 104.8 | 138.4 | 142.9 |
| Silicone-5 | 7.2 | — | — | — | — | — | 26.7 | — | — |
| Silicone-6 | — | — | — | — | — | — | — | 3.10 | — |
| Silicone-7 | — | — | — | — | — | — | — | — | — |
| Extra | 35.2 | — | — | — | — | — | — | — | — |
| Tackifier (T1) | | | | | | | | | |
| Thermal | — | — | — | — | — | — | — | — | — |
| radical initiator | | | | | | | | | |
| Toluene | 41.7 | 23.8 | 23.8 | 23.8 | 23.8 | — | 22.4 | 12.4 | 23.8 |
| Total | 166.6 | 166.7 | 166.7 | 166.7 | 166.7 | 166.7 | 153.8 | 153.9 | 166.7 |
| Solids | 100.0 | 100.0 | 100.0 | 100.0 | 100.0 | 100.0 | 100.0 | 100.0 | 100.0 |
| Solids % | 60% | 60% | 60% | 60% | 60% | 60% | 65% | 65% | 60% |
| Total Silicone | 36.0 | 36.0 | 36.0 | 34.0 | 34.0 | 34.0 | 7.3 | 32.9 | 32.0 |
| Total Tackifier | 64.0 | 64.0 | 64.0 | 66.0 | 66.0 | 66.0 | 66.0 | 64.0 | 68.0 |
| E-beam Mrad | 6 | 6 | 6 | 6 | 6 | 6 | 6 | 6 | 6 |
| Gamm Mrad | — | — | — | — | — | — | — | — | — |
| Thermal cure | — | — | — | — | — | — | — | — | — |

* = Synthetic Polymers

TABLE 3

| | E16 | E17 | E18 | CE4 | CE5 | CE6 |
|---|---|---|---|---|---|---|
| SP * | 142.9 | 142.9 | 142.9 | 142.9 | 142.9 | 142.9 |
| Silicone-5 | — | — | — | — | — | — |
| Silicone-6 | — | — | — | — | — | — |
| Silicone-7 | — | — | — | — | — | — |
| Extra | — | — | — | — | — | — |
| Tackifier (T1) | | | | | | |
| Thermal | — | — | — | — | — | — |
| radical initiator | | | | | | |
| Toluene | 23.8 | — | — | — | — | — |
| Total | 166.7 | 142.9 | 142.9 | 142.9 | 142.9 | 142.9 |
| Solids | 100.0 | 100.0 | 100.0 | 100.0 | 100.0 | 100.0 |
| Solids % | 60% | 70% | 70% | 70% | 70% | 70% |
| Total Silicone | 32.0 | 30.0 | 30.0 | 30.0 | 28.0 | 28.0 |
| Total Tackifier | 68.0 | 70.0 | 70.0 | 70.0 | 72.0 | 72.0 |
| E-beam Mrad | 8 | 6 | 8 | 0 | 0 | 8 |
| Gamm Mrad | — | — | — | — | — | — |
| Thermal cure | — | — | — | — | — | — |

* = Synthetic Polymers

TABLE 4

| | CE7 | E19 | E20 | E21 | E22 | E23 |
|---|---|---|---|---|---|---|
| SP * | N/A | 142.9 | 142.9 | 142.9 | 142.9 | 142.9 |
| Silicone-5 | — | — | — | — | — | — |
| Silicone-6 | — | — | — | — | — | — |
| Silicone-7 | 100.0 | — | — | — | — | — |
| Extra | — | — | — | — | — | — |
| Tackifier (T1) | | | | | | |
| Thermal | — | 2.5 | 5.0 | 10.0 | — | — |
| radical initiator | | | | | | |
| Toluene | 23.8 | 23.8 | 23.8 | 23.8 | 23.8 | 23.8 |
| Total | 100.0 | 169.2 | 171.7 | 176.7 | 166.7 | 166.7 |
| Solids | 60.0 | 100.0 | 100.0 | 100.0 | 100.0 | 100.0 |
| Solids % | 60% | 59% | 58% | 57% | 60% | 60% |
| Total Silicone | N/A | 34.0 | 34.0 | 34.0 | 36.0 | 34.0 |
| Total Tackifier | N/A | 66.0 | 66.0 | 66.0 | 64.0 | 66.0 |
| E-beam Mrad | 6 | — | — | — | — | — |
| Gamm Mrad | — | — | — | — | 6 | 6 |
| Thermal cure | — | Yes | Yes | Yes | — | — |

* = Synthetic Polymers;
N/A = Not Applicable

TABLE 5

| Component | CE1 | CE2 | CE3 | E1 | E2 | E3 | E4 | E5 | E6 |
|---|---|---|---|---|---|---|---|---|---|
| Probe tack 5 g | 55.1 | 41.2 | 19.5 | 13.8 | 6.3 | 5.1 | 20.7 | 13.2 | 10.8 |
| (at Low force) | | | | | | | | | |
| Probe tack 20 g | 73.4 | 59.8 | 24.4 | 23.3 | 12.5 | 12.3 | 31.6 | 23.2 | 16.7 |
| Probe tack 150 g | 159.1 | 117.4 | 52.7 | 64.3 | 42.0 | 45.0 | 97.1 | 87.2 | 57.5 |
| (at High force) | | | | | | | | | |
| PAA ratio (High | 2.9 | 2.9 | 2.7 | 4.7 | 6.7 | 8.9 | 4.7 | 6.6 | 5.3 |
| force/Low force) | | | | | | | | | |
| Peel Adhesion* | 9.4 | 5.7 | 3.4 | 9.0 | 11.4 | 13.3 | 15.5 | 16.4 | 10.7 |
| Failure Mode | PO | PO | PO | PO | PO | PO | PO | PO | PO |
| Gel Fraction (%) | 0% | 56% | 66% | 53% | 50% | 48% | 37% | 31% | 20% |
| Liner Release* | 0.24 | 3.12 | 0.25 | 0.28 | 0.22 | 0.17 | 0.08 | 0.02 | 0.02 |
| G′ at 23deg C. | NT | 0.1 | 0.7 | 4.4 | 8.9 | 14.7 | 4.7 | 9.2 | 11.9 |
| (DMA) (MPa) | | | | | | | | | |
| Tanδ at 23deg C. | NT | 0.63 | 0.76 | 0.44 | 0.37 | 0.29 | 0.54 | 0.43 | 0.40 |
| (DMA) (MPa) | | | | | | | | | |
| Tg (DMA) (° C.) | N/A | 0 | 40 | 77 | 91 | 108 | 72 | 86 | 98 |

NT = Not Tested;
N/A = Not Applicable;
*= N/25 mm

TABLE 6

| Component | E7 | E8 | E9 | E10 | E11 | E12 | E13 | E14 | E15 |
|---|---|---|---|---|---|---|---|---|---|
| Probe tack 5 g | 18.7 | 18.4 | 12.7 | 9.1 | 6.5 | 8.1 | 5.2 | 4.9 | 7.1 |
| (at Low force) | | | | | | | | | |
| Probe tack 20 g | 36.7 | 33.3 | 22.8 | 14.0 | 12.7 | 11.4 | 8.9 | 8.3 | 8.8 |
| Probe tack 150 g | 104.4 | 104.9 | 82.5 | 68.7 | 63.2 | 55.2 | 25.6 | 34.6 | 45.2 |
| (at High force) | | | | | | | | | |
| PAA ratio (High | 5.6 | 5.7 | 6.5 | 7.6 | 9.7 | 6.8 | 4.9 | 7.1 | 6.4 |
| force/Low force) | | | | | | | | | |
| Peel Adhesion* | 12.0 | 17.0 | 14.8 | 17.7 | 15.7 | 13.5 | 9.2 | 15.4 | 18.9 |
| Failure Mode | PO | PO | PO | PO | PO | PO | PO | PO | PO |
| Gel Fraction (%) | 36% | 35% | 42% | 25% | 28% | 31% | 12% | 27% | 20% |
| Liner Release* | 0.04 | 0.03 | 0.02 | 0.02 | 0.02 | 0.02 | 0.01 | 0.01 | 0.01 |
| G′ at 23deg C. | 3.5 | 6.4 | 9.7 | 15.1 | 16.7 | 15.8 | 30.9 | 22.8 | 24.5 |
| (DMA) (MPa) | | | | | | | | | |
| Tanδ at 23deg C. | 0.59 | 0.51 | 0.39 | 0.35 | 0.32 | 0.33 | 0.27 | 0.26 | 0.28 |
| (DMA) (MPa) | | | | | | | | | |
| Tg (DMA) (° C.) | 65 | 75 | 92 | 99 | 108 | 103 | 118 | 125 | 114 |

*= N/25 mm

TABLE 7

| Component | E16 | E17 | E18 | CE4 | CE5 | CE6 |
|---|---|---|---|---|---|---|
| Probe tack 5 g | 7.6 | 6.0 | 6.0 | 6.1 | 5.3 | 5.9 |
| (at Low force) | | | | | | |
| Probe tack 20 g | 9.8 | 7.5 | 6.9 | 5.6 | 4.9 | 6.2 |
| Probe tack 150 g | 49.2 | 21.1 | 28.1 | 10.3 | 6.4 | 12.4 |
| (at High force) | | | | | | |
| PAA ratio (High | 6.4 | 3.5 | 4.7 | 1.7 | 1.2 | 2.1 |
| force/Low force) | | | | | | |
| Peel Adhesion* | 19.8 | 15.3 | 13.2 | 1.5 | 0.0 | 2.1 |
| Failure Mode | PO | PO/AN | PO/AN | PO | PO | PO |
| Gel Fraction (%) | 33% | 18% | 34% | 0% | 0% | 24% |
| Liner Release* | 0.02 | 0.01 | 0.01 | 0.004 | 0.004 | 0.01 |
| G′ at 23deg C. | 22.9 | 35.2 | 31.6 | 37.5 | 46.4 | 49.4 |
| (DMA) (MPa) | | | | | | |
| Tanδ at 23deg C. | 0.28 | 0.23 | 0.23 | 0.24 | 0.19 | 0.19 |
| (DMA) (MPa) | | | | | | |
| Tg (DMA) (° C.) | 112 | 133 | 130 | N/A | N/A | 150 |

N/A = Not Applicable;
*= N/25 mm

TABLE 8

| Component | CE7 | E19 | E20 | E21 | E22 | E23 |
|---|---|---|---|---|---|---|
| Probe tack 5 g | 48.5 | 7.3 | 9.2 | 9.0 | 13.5 | 8.2 |
| (at Low force) | | | | | | |
| Probe tack 20 g | 76.2 | 12.1 | 15.7 | 14.5 | 22.3 | 17.6 |
| Probe tack 150 g | 128.5 | 69.5 | 76.3 | 81.0 | 73.9 | 76.0 |
| (at High force) | | | | | | |
| PAA ratio (High | 2.6 | 9.5 | 8.3 | 9.0 | 5.5 | 9.2 |
| force/Low force) | | | | | | |
| Peel Adhesion* | 13.4 | 16.2 | 16.6 | 19.6 | 16.8 | 17.9 |
| Failure Mode | PO | PO | PO | PO | PO | PO |
| Gel Fraction (%) | 47% | 2% | 35% | 50% | 32% | 28% |
| Liner Release* | 0.30 | 0.003 | 0.02 | 0.03 | 0.03 | 0.02 |
| G′ at 23deg C. | 0.2 | 24.4 | NT | 22.4 | 9.3 | 16.2 |
| (DMA) (MPa) | | | | | | |
| Tanδ at 23deg C. | 0.79 | 0.29 | NT | 0.24 | 0.41 | 0.34 |
| (DMA) (MPa) | | | | | | |
| Tg (DMA) (° C.) | 33 | 119 | NT | 109 | 87 | 101 |

NT = Not Tested;
*= N/25 mm

### Example Set II. Non-MQ-resin Capped Examples

### Test Methods

### Tack—Probe Tack Test

The probe tack test was evaluated by using a Texture analyzer. A testing strip of 5 in long and 1 in wide is mounted onto the underside of a steel plate that has multiple holes where the probe will be lowered to touch the adhesive for an allotted amount of time. This steel plate plus adhesive construction is then placed onto a stage with the probe directly above one of the holes. The probe is lowered and adheres to the samples adhesive side. Depending on the target force and the contact time, the probe will pull away from the adhesive, and the force required to pull the probe from the adhesive face is measured as adhesive force.

The details of the test conditions are as follows.

Stainless Steel Probe:

| Device: | Texture Analyzer | |
|---|---|---|
| Probe label: | TA-57R | |
| Probe size (diameter): | 7 | mm |
| Probe shape: | Round type 7 mm-1″ | |
| | R (Stable Micro Systems) | |
| Probe material: | Stainless steel | |
| Trigger force: | 1 | g |
| Target force: | 5 g, 150 g | |
| Pre-test speed from | 0.05 | mm/sec |
| trigger to target force: | | |
| Contact time: | 1 | sec |
| Test speed: | 10 | mm/sec |

| | |
|---|---|
| Proportional-Integral- | 10 (P) 5 (I) 15 (D) |
| Differential (PID): | |
| Test atmosphere: | 23° C./50% RH |
| Repeat test number: | N5 |

Polypropylene Probe:

| Device: | Texture Analyzer | |
|---|---|---|
| Probe size (diameter): | 7 | mm |
| Probe shape: | Round type 7 mm-1″ | |
| | R (Stable Micro Systems) | |
| Probe material: | Polypropylene | |
| Trigger force: | 1 | g |
| Target force: | 10 g, 2000 g | |
| Pre-test speed from | 0.05 | mm/sec |
| trigger to target force: | | |
| Contact time: | 0.1 | sec |
| Test speed: | 10 | mm/sec |

| | |
|---|---|
| Proportional-Integral- | 10 (P) 5 (I) 15 (D) |
| Differential (PID): | |
| Test atmosphere: | 23° C./50% RH |
| Repeat test number: | N5 |

The area under the curve was recorded as the probe tack force, and the average value by n5 noted.

### Liner Release Force

Liner release force was evaluated with an IMASS Model SP-2300 tester. The liner side of a test piece of 8 inches×1 inch (20 cm×2.5 cm) was applied on the measurement stage by double coated tape and the edge of the adhesive construction was pinched with a chuck to perform the measurement. Test speed was 12 in/min (30 cm/min) or 90 in/min (229 cm/min) and the result is an average of 3 tests. The results are presented in N/25 mm.

In this disclosure, a release liner force of 0.3N/25 mm or less was defined as good liner release level.

### Peel Adhesion Force

Peel adhesion force was measured by IMASS SP-2300. Each testing strip was applied to a clean polypropylene panel at 23° C./50% RH. Each testing strip was 6 inch (15 cm)×1 inch (2.5 cm). The testing strips were laid down on the polypropylene panel and a 2 Kg roller was rolled across the testing strip for one down and back cycle. The samples dwelled on the panel for either 5 min or 30 min before testing. Another set of testing was putting the testing strip down onto the polypropylene panel and instead of a 2 Kg roller, very light finger pressure was used to laminate and push the air pockets out. This then dwelled for 5 min before testing. The 1800 Peel tests were run at 90 in/min (229 cm/min) and the reported value is the average of 3 tests in N/25 mm. The fracture mode was also recorded as PO: Pop off (it means clean peel) or AN: Anchor failure.

### Tensile Strength and Elongation at Break

Tensile force and elongation at break were measured by an Instron 5900 Series. Dog bone shaped testing samples were cut with a die cutter and clamped into the jaws/grips of the Instron to produce the tensile force and elongation at break. The force at material rupture is known as the tensile strength (psi), and the distance the test sample stretch is known as the elongation at break (%).

### Examples

### Preparation of Comparative Examples CE8-CE11

For Comparative Example CE8, Tape-1 was used as supplied. For Comparative Examples CE9-CE11, Silicone-5 and Tackifier-1-were mixed in a twin screw extruder at the ratios according to the Table 9 below and coated on Backing-3 through a rotary rod die at 51 micrometer (2 mil) thickness and cured with E-beam radiation with 300 kev and the doses shown in Table 9. The prepared samples were tested and the results are shown in Table 10.

TABLE 9

| Samples | CE8 | CE9 | CE10 | CE11 |
|---|---|---|---|---|
| Backing | Polypropylene | B2 | B2 | B2 |
| Silicone | synthetic | 53% | 50% | 48% |
| | rubber | S5 | S5 | S5 |
| Silicone | adhesive | 47% | 50% | 52% |
| Tackifier | | T1 | T1 | T1 |
| Solvent | NA | NA | NA | NA |
| Curing/ | NA | 5Mr | 3Mr | 5Mr |
| Drying | | | | |

TABLE 10

| Component | | CE8 | CE9 | CE10 | CE11 |
|---|---|---|---|---|---|
| Probe tack (SS | probe adhesion w/ | 86.9 | 243.9 | 465.3 | 254.7 |
| Probe) | 5 g applied force | | | | |
| | probe adhesion w/ | 112 | 291.5 | 496.4 | 275 |
| | 150 g applied force | | | | |
| | Ratio High/low | 1.3 | 1.2 | 1.1 | 1.1 |
| Probe tack (PP | probe adhesion w/ | 124.2 | 540.8 | 673.3 | 533.9 |
| Probe) | 10 g applied force | | | | |
| | probe adhesion | 1555.8 | 2312.6 | 2176.1 | 1930.9 |
| | w/2000 g applied | | | | |
| | force | | | | |
| | Ratio High/Low | 12.5 | 4.3 | 3.2 | 3.6 |
| Peel Adhesion | 5 min dwell, | 14.0 | 3.6 | 4.4 | 5.4 |
| N/25 mm (oz/in) | 4.5 lbs rolldown | (51.3) | (13.2) | (16.2) | (19.7) |
| | 30 min dwell, | 14.3 | 4.1 | 4.7 | 5.7 |
| | 4.5 lbs rolldown | (52.1) | (15) | (17.3) | (20.7) |
| | 5 min dwell, light | 14.0 | 3.6 | 4.2 | 5.3 |
| | finger pressure | (51.1) | (13.1) | (15.3) | (19.3) |
| Liner-3 Release | Initial | NT | NT | NT | NT |
| @90 in/min | 7 D at CTH | NT | NT | NT | NT |
| N/25 mm (g/in) | 7 D at 70° C. | NT | NT | NT | NT |
| Liner-2 Release | Initial | 0.97 | NT | NT | NT |
| @90 in/min | | (100.2) | | | |
| N/25 mm (g/in) | 7 D at CTH | 1.00 | NT | NT | NT |
| | | (103.3) | | | |
| | 7 D at 70° C. | 1.07 | NT | NT | NT |
| | | (111.2) | | | |
| Liner-4 Release | Initial | NT | NT | NT | NT |
| @90 in/min | 7 D at CTH | NT | NT | NT | NT |
| N/25 mm (g/in) | 7 D at 70° C. | NT | NT | NT | NT |
| Liner-2 Release | Iniital | 3.2 | 0.31 | 0.30 | 0.25 |
| @12 in/min | | (330.6) | (32.1) | (31.2) | (25.8) |
| N/25 mm (g/in) | | | | | |
| Liner-4 Release | Initial | 0.011 | 0.15 | 0.070 | 0.038 |
| @12 in/min | | (1.1) | (15.6) | (7.3) | (3.9) |
| N/25 mm (g/in) | | | | | |

NT = Not Tested

### Preparation of Examples E24-E32

For example E24 the Silicone Adhesive 1 (SA) was coated on liner-4, dried and cured at 70° C. for 15 min, to give an adhesive layer with a thickness of 51 micrometers (2 mils), and laminated to Backing-4.

For example E25-E30; Silicone-5 and Tackifier-1-were mixed in twin screw extruder at the ratios according to Table 11, coated on the Backing listed in Table 11 through a rotary rod die to the thickness shown in Table 11, and cured with E-beam radiation with 200 kev (except for E25 300 kev) and doses shown in Table 11. Examples E28-E29 were coated and cured on Liner 5 and then laminated to the Backing-4.

For Examples E31-E32 Silicone-8 (silicone polyoxamide copolymer) and Tackifier-2 were mixed at the ratio according to the table 11 in THF at 35% solids. The solution was coated onto Liner-4 through a knife coated with a 178 micrometer (7 mil) gap and dried at 70° C. for 15 minutes to a thickness of 25 micrometers (1 mil).

The prepared samples were tested and the results are shown in Tables 12 and 13.

TABLE 11

| Samples | E24 | E25 | E26 | E27 | E28 | E29 | E30 | E31 | E32 |
|---|---|---|---|---|---|---|---|---|---|
| Backing | B4 | B3 | B4 | B4 | B4 | B4 | B5 | B4 | B4 |
| Silicone | SA | 32% | 32% | 32% | 36% | 36% | 36% | 38% | 36% |
| | DC7658 | S5 | S5 | S5 | S5 | S5 | S5 | S8 | S8 |
| Silicone | | 68% | 68% | 68% | 64% | 64% | 64% | 62% | 64% |
| Tackifier | | T1 | T1 | T1 | T1 | T1 | T1 | T2 | T2 |
| Solvent | Toluene | NA | NA | NA | NA | NA | NA | THF | THF |
| Curing/Drying | 70° C. | 5Mr | 7Mr | 9Mr | 3Mr | 5Mr | 5Mr | 70° C. | 70° C. |
| Thickness | 51 | 102 | 51 | 51 | 51 | 51 | 51 | 25 | 25 |
| (micrometer) | | | | | | | | | |

TABLE 12

| Component | | E24 | E25 | E26 | E27 |
|---|---|---|---|---|---|
| Probe tack | probe adhesion w/5 g | 34.9 | 16.9 | 10.8 | 9.6 |
| (SS Probe) | applied force | | | | |
| | probe adhesion w/150 g | 156.2 | 62.5 | 41.6 | 31.6 |
| | applied force | | | | |
| | Ratio High/Low | 4.5 | 3.7 | 3.8 | 3.3 |
| Probe tack | probe adhesion w/10 g | 43.5 | 25.5 | 13.8 | 12.7 |
| (PP Probe) | applied force | | | | |
| | probe adhesion w/2000 g | 6875 | 1764.2 | 1713.5 | 1669.8 |
| | applied force | | | | |
| | Ratio High/Low | 158.2 | 69.2 | 124.3 | 132 |
| Peel | 5 min dwell, 4.5 lbs | 19.6 | 8.2 | 11.9 | 3.8 |
| Adhesion | rolldown | (71.7) | (30) | (43.4) | (35) |
| N/25 mm | 30 min dwell, 4.5 lbs | 20.9 | 10.3 | 17.5 | 13.2 |
| (oz/in) | rolldown | (76.3) | (37.7) | (63.9) | (48.1) |
| | 5 min dwell, light finger | 1.1 | 2.5 | 0.88 | 0.57 |
| | pressure | (3.8) | (9.3) | (3.2) | (2.1) |
| Liner-3 | Initial | NT | NT | 0.015 | 0.013 |
| Release | | | | (1.6) | (1.3) |
| @90 in/min | 7 D at CTH | NT | NT | 0.028 | 0.025 |
| N/25 mm | | | | (2.9) | (2.6) |
| (g/in) | 7 D at 70° C. | NT | NT | 0.015 | 0.013 |
| | | | | (1.6) | (1.3) |
| Liner-2 | Initial | 0.15 | 0.68 | 0.058 | 0.055 |
| Release | | (15.1) | (70.3) | (6.0) | (5.7) |
| @90 in/min | 7 D at CTH | 0.29 | 0.73 | 0.15 | 0.13 |
| N/25 mm | | (30.3) | (75.8) | (15.6) | (13.1) |
| (g/in) | 7 D at 70° C. | 0.29 | 0.87 | 0.20 | 0.16 |
| | | (29.7) | (89.8) | (20.4) | (16.3) |
| Liner-4 | Initial | NT | NT | 0.0039 | 0.0029 |
| Release | | | | (0.4) | (0.3) |
| @90 in/min | 7 D at CTH | NT | NT | 0.028 | 0.021 |
| N/25 mm | | | | (2.9) | (2.2) |
| (g/in) | 7 D at 70° C. | NT | NT | 0.012 | 0.012 |
| | | | | (1.2) | (1.2) |
| Liner-2 | Initial | 0.15 | 0.21 | 0.014 | 0.014 |
| Release | | (15.4) | (21.7) | (1.5) | (1.5) |
| @12 in/min | | | | | |
| (g/in) | | | | | |
| Liner-4 | Initial | 0.0077 | 0.023 | 0.0077 | 0.0058 |
| Release | | (0.8) | (2.4) | (0.8) | (0.6) |
| @12 in/min | | | | | |
| (g/in) | | | | | |
| Tensile at | | 1557 | NT | 1358 | 1124 |
| Break kPa | | (225.8) | | (196.9) | (163) |
| (psi) (down | | | | | |
| web) Initial | | | | | |
| Elongation | | 94 | NT | 93 | 74 |
| at Break | | | | | |
| (%) (down | | | | | |
| web) Initial | | | | | |
| Tensile at | | 1367 | NT | 1068 | 1021 |
| Break kPa | | (198.2) | | (154.9) | (148.1) |
| (psi) (down | | | | | |
| web) 2 | | | | | |
| weeks @ | | | | | |
| 70° C. | | | | | |
| Elongation | | 68 | NT | 29 | 17 |
| at Break | | | | | |
| (%) (down | | | | | |
| web) 2 | | | | | |
| weeks @ | | | | | |
| 70° C. | | | | | |
| Tensile at | | 3416 | NT | 1642 | 2090 |
| Break kPa | | (495.5) | | (238.1) | (303.1) |
| (psi) (cross | | | | | |
| web) Initial | | | | | |
| Elongation | | 42 | NT | 37 | 39 |
| at Break | | | | | |
| (%) (cross | | | | | |
| web) Initial | | | | | |
| Tensile at | | 1844 | NT | 1434 | 1144 |
| Break kPa | | (267.5) | | (208.8) | (165.9) |
| (psi) (cross | | | | | |
| web) 2 | | | | | |
| weeks @ | | | | | |
| 70° C. | | | | | |
| Elongation | | 5 | NT | 11 | 13 |
| at Break | | | | | |
| (%) (cross | | | | | |
| web) 2 | | | | | |
| weeks @ | | | | | |
| 70° C. | | | | | |

TABLE 13

| Component | | E28 | E29 | E30 | E31 | E32 |
|---|---|---|---|---|---|---|
| Probe tack | probe adhesion w/5 g | 74.1 | 59.7 | 42.7 | NT | NT |
| (SS Probe) | applied force | | | | | |
| | probe adhesion w/150 g | 263.4 | 237.1 | 130.6 | NT | NT |
| | applied force | | | | | |
| | Ratio high/Low | 3.6 | 4 | 3.1 | NT | NT |
| Probe tack | probe adhesion w/10 g | 131.9 | 88.3 | 59.4 | NT | NT |
| (PP Probe) | applied force | | | | | |
| | probe adhesion | 3489.3 | 3040.2 | 3103.7 | NT | NT |
| | w/2000 g applied force | | | | | |
| | Ratio High/Low | 26.5 | 34.5 | 52.3 | NT | NT |
| Peel | 5 min dwell, 4.5 lbs | 14.2 | 17.1 | 9.9 | 13.5 | 8.2 |
| Adhesion | rolldown | (51.8) | (62.4) | (36.3) | (49.4) | (30.1) |
| N/25 mm | 30 min dwell, 4.5 lbs | 14.6 | 19.1 | 11.1 | | |
| (oz/in) | rolldown | (53.4) | (69.6) | (40.6) | | |
| | 5 min dwell, light finger | 4.1 | 2.6 | 6.0 | | |
| | pressure | (14.8) | (9.5) | (22) | | |
| Liner-3 | Initial | 0.021 | 0.016 | NT | | |
| Release | | (2.2) | (1.7) | | | |
| @90 in/min | 7 D at CTH | 0.940 | 0.034 | NT | | |
| N/25 mm | | (4.1) | (3.5) | | | |
| (g/in) | 7 D at 70° C. | 0.017 | 0.016 | NT | | |
| | | (1.8) | (1.7) | | | |
| Liner-2 | Initial | 1.66 | 1.59 | 1.57 | | |
| Release | | (172.1) | (164.8) | (162.8) | | |
| @90 in/min | 7 D at CTH | 1.34 | 1.72 | 1.83 | | |
| N/25 mm | | (139.3) | (178.3) | (189.4) | | |
| (g/in) | 7 D at 70° C. | 1.35 | 1.41 | 3.43 | | |
| | | (139.6) | (146.2) | (355.7) | | |
| Liner-4 | Initial | 0.0020 | 0.013 | NT | 0.13 | 0.062 |
| Release | | (2.1) | (1.3) | | (13.2) | (6.4) |
| @90 in/min | 7 D at CTH | 0.042 | 0.037 | NT | 0.12 | 0.068 |
| N/25 mm | | (4.3) | (3.8) | | (12.7) | (7.1) |
| (g/in) | 7 D at 70° C. | 0.018 | 0.018 | NT | 0.26 | 0.19 |
| | | (1.9) | (1.9) | | (26.6) | (19.3) |
| Liner-2 | Initial | 1.51 | 1.44 | 1.54 | | |
| Release | | (156.3) | (148.7) | (159.4) | | |
| @12 in/min | | | | | | |
| N/25 mm | | | | | | |
| (g/in) | | | | | | |
| Liner-4 | Initial | 0.019 | 0.013 | 0.11 | | |
| Release | | (2.0) | (1.3) | (10.9) | | |
| @12 in/min | | | | | | |
| N/25 mm | | | | | | |
| (g/in) | | | | | | |
| Tensile at | | 1110 | 1496 | NT | | |
| Break kPa | | (161) | (217) | | | |
| (psi) (down | | | | | | |
| web) Initial | | | | | | |
| Elongation | | 45 | 82 | NT | | |
| at Break (%) | | | | | | |
| (down web) | | | | | | |
| Initial | | | | | | |
| Tensile at | | 487 | 137 | NT | | |
| Break kPa | | (70.6) | (19.8) | | | |
| (psi) (down | | | | | | |
| web) 2 | | | | | | |
| weeks @ | | | | | | |
| 70° C. | | | | | | |
| Elongation | | 18 | 11 | NT | | |
| at Break (%) | | | | | | |
| (down web) | | | | | | |
| 2 weeks @ | | | | | | |
| 70° C. | | | | | | |
| Tensile at | | 2970 | 3091 | NT | | |
| Break kPa | | (430.7) | (448.3) | | | |
| (psi) (cross | | | | | | |
| web) Initial | | | | | | |
| Elongation | | 43 | 43 | NT | | |
| at Break (%) | | | | | | |
| (cross web) | | | | | | |
| Initial | | | | | | |
| Tensile at | | 2164 | 2036 | NT | | |
| Break kPa | | (313.9) | (295.3) | | | |
| (psi) (cross | | | | | | |
| web) 2 | | | | | | |
| weeks @ | | | | | | |
| 70° C. | | | | | | |
| Elongation | | 11 | 9 | NT | | |
| at Break (%) | | | | | | |
| (cross web) | | | | | | |
| 2 weeks @ | | | | | | |
| 70° C. | | | | | | |

1. A pressure activated adhesive article comprising:
a first substrate with a first major surface and a second major surface; and
a pressure activated adhesive layer disposed on at least a portion of the second major surface of the first substrate, the pressure activated adhesive layer comprising a crosslinked adhesive composition, wherein the crosslinked adhesive composition comprises:
at least one siloxane polymer that has been crosslinked; and
at least one siloxane tackifying resin;
wherein the crosslinked adhesive composition is a pressure activated adhesive that is non-adhesive at room temperature having a Tg of at least 50° C. as measured by DMA (Dynamic Mechanical Analysis), but upon application of pressure to the adhesive layer the adhesive layer adheres to a substrate.

2. The article of claim 1, wherein the first substrate comprises a release liner or a tape backing.

3. The article of claim 1, wherein the first substrate comprises a tape backing wherein the tape backing is optically transparent and comprises polyester, polycarbonate, PS (polystyrene), CBC (cyclic block copolymers), and a polyolefin selected from the group consisting of BOPP (biaxially oriented polypropylene, COP (cyclic olefin polymer), COC (cyclic olefin copolymer), polypentene, Glass film, and a combination thereof.

4. The article of claim 1, wherein the first substrate comprises a release liner, and wherein the article further comprises a second substrate with a first major surface and a second major surface, wherein the first major surface of the second substrate is disposed on the adhesive layer, and wherein the second substrate comprises a release liner or a tape backing.

5. The article of claim 1, wherein the at least one siloxane polymer comprises a silanol-functional siloxane polymer that has been end-capped with a siloxane tackifying resin.

6. The article of claim 5, wherein the at least one siloxane polymer further comprises at least one functional group selected from the group consisting of an alkene, a (meth)acrylate, a thiol and a combination thereof.

7. The article of claim 1, wherein the at least one siloxane polymer comprises a non-functional siloxane polymer or a siloxane block copolymer.

8. The article of claim 1, wherein the at least one siloxane tackifying resin comprises MQ resin in an amount of 52-72 weight %, based on the total weight of the crosslinked adhesive composition.

9. The article of claim 6, wherein the at least one siloxane polymer has been crosslinked by free radical polymerization, a thiol-ene reaction, or a combination thereof.

10. The article of claim 1, wherein the at least one siloxane polymer has been crosslinked by peroxide curing, ionizing radiation, or a combination thereof, wherein ionizing radiation comprises e-beam radiation or gamma radiation.

11. The article of claim 1, wherein the pressure activated adhesive article is capable of bonding to a surface comprising a medium surface energy of from 36-300 dynes/cm (0.036-0.30 N/m) or a low surface energy of less than 36 dynes/cm (0.36 N/m), wherein the low surface energy surface comprises a film or rigid plate of PE (polyethylene), PS (polystyrene), PC (polycarbonate), PET (polyethylene terephthalate), PP (polypropylene), COC (cyclic olefin copolymer), COP (cyclic olefin polymer), PDMS (polydimethylsiloxane), or combinations thereof.

12. The article of claim 1, wherein the pressure activated adhesive article is optically transparent.

13. An adhesive composition comprising:
at least one siloxane polymer that has been crosslinked; and
from 52-72% by weight of at least one siloxane tackifying resin based on the total weight of the adhesive composition;
wherein the adhesive composition is a pressure activated adhesive that is non-adhesive at room temperature, has a Tg of at least 50° C. as measured by DMA (Dynamic Mechanical Analysis), but when formed into a layer, upon application of pressure to the adhesive layer, the adhesive layer adheres to a substrate.

14. The adhesive composition of claim 13, wherein the at least one siloxane polymer comprises a silanol-functional siloxane polymer that has been end-capped with a siloxane tackifying resin.

15. The adhesive composition of claim 14, wherein the at least one siloxane polymer further comprises at least one functional group selected from the group consisting of an alkene, a hydride, a vinyl ether, a (meth)acrylate, a thiol or and a combination thereof.

16. (canceled)

17. (canceled)

18. (canceled)

19. (canceled)

20. (canceled)

21. (canceled)
